(19) United States
(12) Patent Application Publication
(10) Pub. No.: US 2008/0201303 A1
(43) Pub. Date: Aug. 21, 2008

(54) METHOD AND SYSTEM FOR A WIZARD BASED COMPLEX FILTER WITH REALTIME FEEDBACK

(75) Inventors: John S. Bragiel, Cary, NC (US); Richard F. Bryan, Clinton, NC (US)

Correspondence Address: CANTOR COLBURN LLP - IBM TUSCON DIVISION, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/676,663

(22) Filed: Feb. 20, 2007

(51) Int. Cl. G06F 17/30

(52) U.S. Cl. 707/3; 707/E17.108

(57) ABSTRACT

A method for implementing a software based wizard interface to filter a set of targets in real-time with filter criteria includes receiving, at the wizard interface, user filter criteria; querying a data set based on the filter criteria; providing filtered data from the data set to a user; determining whether the filtered data meets a user's requirements; closing the wizard interface in the event the filtered data meets the user's requirements; wherein the filter criteria is input into a control pane, and the filtered data is displayed on a results pane that form the wizard interface; wherein the control pane and the results pane are continuously displayed by the wizard interface; and wherein the filter wizard is configured for the user to make adjustments to the filter criteria by navigating backward and forward in the control pane without having to complete, exit, or relaunch the filter wizard.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention relates generally to a software wizard interface, and more particularly to providing a method, article, and system that filter a set of targets in real-time with a complex set of filter criteria. The wizard interface allows a user to quickly make adjustments to the filter criteria without having to complete and possibly relaunch the wizard.

2. Description of the Related Art

A wizard is an interactive computer program which acts as an interface to lead a user through a complex task, using step-by-step dialogs. In some open source software they are called Druids. Other software products, such as database application development tools, call them “Genies” to reflect the “magical” help they give users. Microsoft's Windows 95 was the first operating system to make use of wizards. The Windows 95 operating system (OS) implemted the most commonly-used wizard at the time called the Internet Connection Wizard, which guideg the user through the process of creating a connection to the Internet, or to a Virtual Private Network. By 2001, wizards had become commonplace in most consumer-oriented operating systems. In Apple Inc.'s Mac OS X, for example, they wizards are called “Assistants”; some examples include the “Setup Assistant”, which is run when one boots the Macintosh for the first time, and the “Network Setup Assistant”, which has similar function to the aforementioned “Internet Connection Wizard”. Web applications, such as an airline booking site, also make use of the wizard paradigm to complete lengthy interactive processes. By contrast, expert systems guide the user through a series of (usually yes/no) questions to solve a problem, and tend to make use of artificial intelligence or other complex algorithms. Some consider expert systems as a general category that includes all problem-solving programs including wizards.

Wizards generally employ modal windows. In user interface design, a modal window (often called modal dialog because the window is almost always used to display a dialog box) is a child window, which has to be closed before the user can return to operating the parent application. Modal windows are commonly used in graphical user interface (GUI) systems to absorb user awareness and to display emergency states. Frequently, modal windows are an element of Multiple Document Interface applications. For example, a spreadsheet program might ask the user whether they want to delete a specific cell or row.

Wizards act as filters of information or items in a database, for example searching for one or more items from a collection of many, or searching for a target on which to perform an action. Solutions for filtering a large data set to find a specific target include: searching as a user types in a single text field, for example in the Lotus Notes address book, so the user can quickly choose their target. The dataset narrows with each keystroke, but allows the user to choose their target before completing the string they are typing. However, entering text in a single text field cannot filter some sets of data. For these sets of data, a second approach is used. A complex, multi-panel wizard is employed to find a specific target. Currently, filter wizards launch in a separate window and require completion of every step of the wizard before allowing the user to see filtered results and choose the intended target.

### SUMMARY OF THE INVENTION

Embodiments of the present invention include a method and system for implementing a software based wizard interface to filter a set of targets in real-time with a complex set of filter criteria, wherein the method includes: receiving, at the wizard interface, user inputted filter criteria; querying a data set based on the inputted filter criteria; providing initially filtered data from the data set to a user based on the inputted filter criteria; determining whether the initially filtered data meets a user's requirements; closing the wizard interface in the event the initially filtered data meets the user's requirements; wherein the filter criteria is input into a control pane, and the provided filtered data is displayed on a results pane; wherein the control pane and the results pane from the wizard interface; wherein the control pane and the results pane are both continuously displayed by the wizard interface; and wherein the filter wizard is configured to allow the user to make adjustments to the filter criteria by navigating backward and forward in the control pane without having to complete, exit, or relaunch the filter wizard.

A system for providing a software based wizard interface to filter a set of targets in real-time with a complex set of filter criteria, the system includes: server devices; client devices; storage mediums; a network; wherein the client devices and server devices are in signal communication with the network; wherein the server devices and the client devices are configured to execute electronic software that manages the wizard interface; wherein the electronic software is resident on a storage medium in signal communication with the server devices; wherein the electronic software queries a database based on the filter criteria; wherein the filter criteria is inputted through a graphical user interface of the wizard interface on the client devices; wherein filtered data from the database is displayed on the graphical user interface of the wizard interface; wherein the filter criteria and the filtered data are simultaneously displayed in separate areas of the graphical user interface; and wherein the filtered data display updates in real time based on changes to the filter criteria.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, a solution is technically achieved for a software wizard interface to filter a set of targets in real-time with a complex set of filter criteria. After completing each wizard panel, the result set is shown to the right of the wizard. A user can select a target from the result set at any point in the wizard, saving the user time in finding the desired target. The wizard interface allows the user to quickly make adjustments to the filter criteria without having to complete and possibly relaunch the wizard.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a block diagram of a wizard system and the wizard system's GUI according to an embodiment of the invention.

FIG. 2 is a flow diagram illustrating a method of implementing a wizard filter according to an embodiment of the invention.

FIG. 3 illustrates a system for implementing embodiments of the invention.

The detailed description explains the preferred embodiments of the invention, together with advantages and features, by way of example with reference to the drawings.

### DETAILED DESCRIPTION

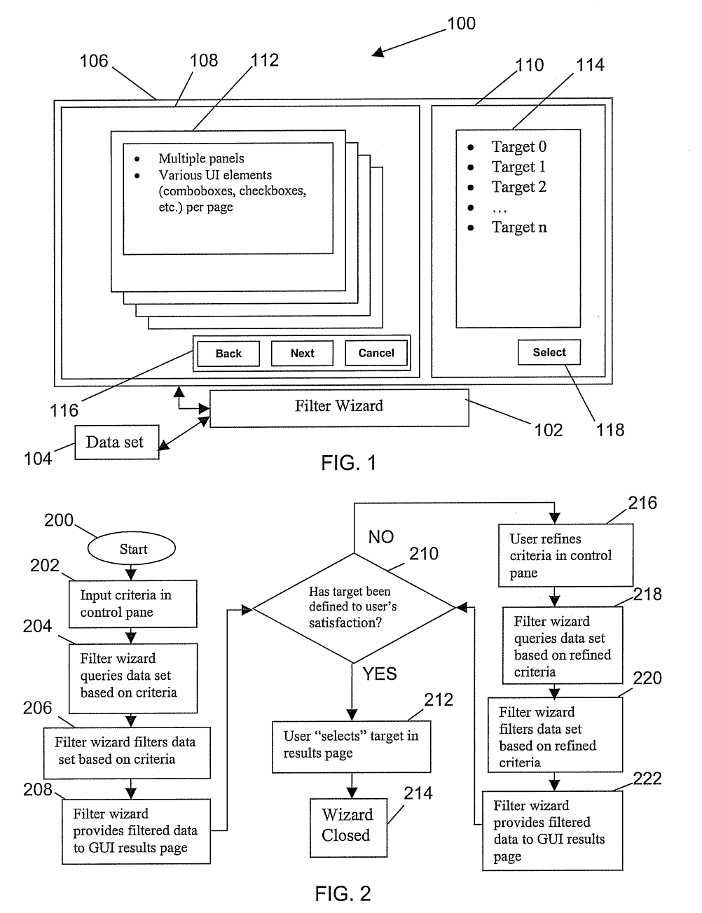

FIG. 1 illustrates a filter wizard system 100 according to an embodiment of the present invention. The filter wizard 102 collects information used to filter the data set 104. The filter wizard 102 powers a GUI 106. The GUI 106 is split into a control pane 108 and a results pane 110. The GUI 106 displays both the control pane 108 and the results pane 110 at the same time. Each pane of the wizard GUI 106 contains various user interface (UI) elements (comboboxes, checkboxes, etc.) that facilitate the creation of filter criteria. When the first page of a series of pages 112 in the control pane 108 is displayed, the entire data set (Target 0 . . . Target n) is shown on results page 114 of the results pane 110. When the user clicks “Next” in the navigation bar 116 on the control pane 108, the criteria on the present page in the series of pages 112 is used to narrow the data set on the results page 114. In this way, the user can quickly make adjustments to the filter criteria without having to complete and possibly relaunch the wizard. These adjustments can be made by clicking “Back” on the navigation bar 116, changing the criteria on the wizard panel, and clicking “Next” again on the navigation bar 116. The user can also choose the intended target at any time in the wizard by selecting one or more items on the results page 114 and pressing the “Select” button 118.

Alternative embodiments of the wizard can have tabs in addition to “Back” and “Next” buttons, where clicking on a tab to navigate through the wizard would cause the results to be refreshed. Another alternative embodiment would have each field update the list of results. Thus, the list would be updated as the user types in the wizard (as opposed to only updating when the “Next” or “Back” buttons are pushed).

FIG. 2 illustrates a flowchart describing a method for using the filter wizard 102 of FIG. 1 according to an embodiment of the invention. The user starts 200 by initiating the filter wizard and inputting request criteria 202 in the control pane 108. The filter wizard 102 queries the data set 104 based on the user inputted criteria. The filter wizard 102 filters data from the data set based on the criteria 206, and provides the filtered data 208 to the GUI results page 114. The user reviews the result page 114 and determines if the target or targets can be easily found 210. If the target(s) is found the user selects the target 212 and the filter wizard 102 closes 214. If the user is not satisfied, the user refines the criteria 216 in the control pane 108. The filter wizard 102 queries the data set 104 based on the refined data 218, and filters the data set 104 based on the refined criteria 220. The filter wizard 102 provides the filtered data to GUI results page 222, where the user makes another attempt to find the desired target(s) 210. The method will continue repeating if the user is not satisfied with the target presented in the result page 114.

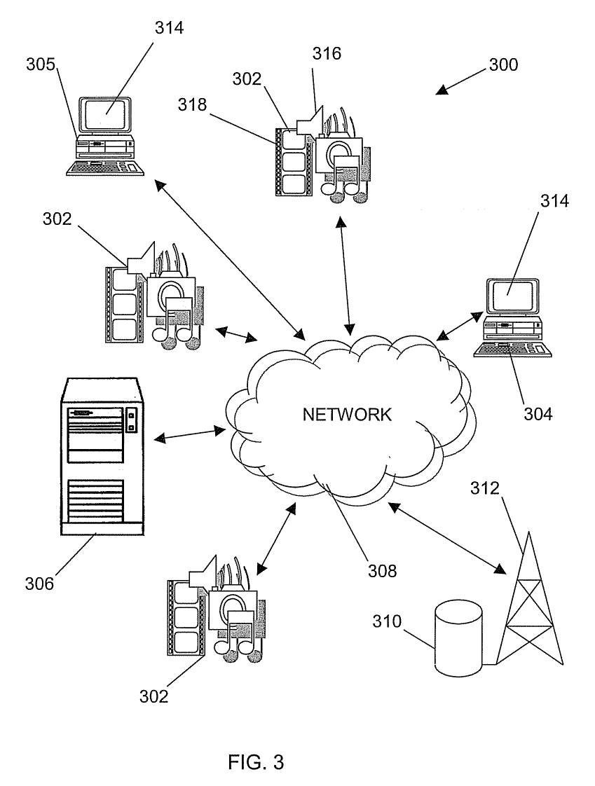

FIG. 3 is a block diagram of an exemplary system 300 for implementing the wizard filter of the present invention and graphically illustrates how those blocks interact in operation. The system 300 includes remote devices including one or more multimedia/communication devices 302 equipped with speakers 316 for implementing audio, as well as display capabilities 318 for facilitating the graphical user interface (GUI) aspects of the present invention. In addition, mobile computing devices 304 and desktop computing devices 305 equipped with displays 314 for use with the GUI of the present invention are also illustrated. The remote devices 302 and 304 may be wirelessly connected to a network 308. The network 308 may be any type of known network including a local area network (LAN), wide area network (WAN), global network (e.g., Internet), intranet, etc. with data/Internet capabilities as represented by server 306. Communication aspects of the network are represented by cellular base station 310 and antenna 312. Each remote device 302 and 304 may be implemented using a general-purpose computer executing a computer program for carrying out embodiments of the wizard filter described herein. The computer program may be resident on a storage medium local to the remote devices 302 and 304, or maybe stored on the server system 306 or cellular base station 310. The server system 306 may belong to a public service. The remote devices 302 and 304, and desktop device 305 may be coupled to the server system 306 through multiple networks (e.g., intranet and Internet) so that not all remote devices 302, 304, and desktop device 305 are coupled to the server system 306 via the same network. The remote devices 302, 304, desktop device 305, and the server system 306 may be connected to the network 308 in a wireless fashion, and network 308 may be a wireless network. In an exemplary embodiment, the network 308 is a LAN and each remote device 302, 304 and desktop device 305 executes a user interface application (e.g., web browser) to contact the server system 306 through the network 308. Alternatively, the remote devices 302 and 304 may be implemented using a device programmed primarily for accessing network 308 such as a remote client.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiments to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for implementing a software based wizard interface to filter a set of targets in real-time with a complex set of filter criteria, wherein the method comprises:
receiving, at the wizard interface, user inputted filter criteria;
querying a data set based on the inputted filter criteria;
providing initially filtered data from the data set to a user based on the inputted filter criteria;
determining whether the initially filtered data meets a user's requirements;
closing the wizard interface in the event the initially filtered data meets the user's requirements;
wherein the filter criteria is input into a control pane, and the provided filtered data is displayed on a results pane;
wherein the control pane and the results pane form the wizard interface;
wherein the control pane and the results pane are both continuously displayed by the wizard interface; and
wherein the filter wizard is configured to allow the user to make adjustments to the filter criteria by navigating backward and forward in the control pane without having to complete, exit, or relaunch the filter wizard.

2. The method of claim 1, further comprising:
receiving refined filter criteria at the wizard interface in the event the initially filtered data does not meet the user's requirements;
querying the data set based on the inputted refined filter criteria;
providing refined filtered data from the data set to the user based on the inputted refined filter criteria;
determining whether the refined filtered data meets a user's requirements;
closing the wizard interface in the event the refined filtered data meets the user's requirements; and
iteratively repeating receiving refined filter criteria, and providing refined filtered data until the user's requirements are met.

3. The method of claim 1, wherein:
the inputting of filter criteria is implemented using comboboxes and checkboxes.

4. The method of claim 1, wherein:
the inputting of filter criteria is implemented with standard user interface components.

5. The method of claim 1, wherein the wizard interface is configured to permit the user to choose their intended target at any time by selecting one or more items on the results pane.

6. A system for providing a software based wizard interface to filter a set of targets in real-time with a complex set of filter criteria, the system comprising:
one or more server devices in communication with one or more client devices through a network;
the server devices and the client devices configured to execute electronic software that manages the wizard interface;
wherein the electronic software is resident on a storage medium in signal communication with the server devices;
wherein the electronic software queries a database based on the filter criteria;
wherein the filter criteria is inputted through a graphical user interface of the wizard interface on the client devices;
wherein filtered data from the database is displayed on the graphical user interface of the wizard interface;
wherein the filter criteria and the filtered data are simultaneously displayed in separate areas of the graphical user interface; and
wherein the filtered data display updates in real time based on changes to the filter criteria.
